(19) United States
(12) Patent Application Publication
(10) Pub. No.: US 2011/0193313 A1
(43) Pub. Date: Aug. 11, 2011

(54) FOLDABLE BICYCLE

(76) Inventor: Keun Soo Yun, Seoul (KR)

(21) Appl. No.: 13/023,969

(22) Filed: Feb. 9, 2011

(30) Foreign Application Priority Data
Feb. 9, 2010 (KR) 10-2010-0011837

(51) Int. Cl. B62K 15/00

(52) U.S. Cl. 280/278

(57) ABSTRACT

Disclosed is a foldable bicycle. The foldable bicycle includes a head frame having a first connection part, a first lower frame integrally formed with the head frame and provided at a terminal end thereof with a second fastening part, a second lower frame provided with a second connection part extending from one side of the perforation hole, a slide member coupled with the second lower frame to slidably move lengthwise along the second lower frame and provided at an upper portion thereof with a third connection part, a saddle frame provided at a lower portion thereof with a third fastening part rotatably coupled with the third connection part, and a horizontal frame provided at one end thereof with a fourth fastening part rotatably coupled with saddle frame, and at the other end thereof with a first fastening part rotatably coupled with a first connection part.

### BACKGROUND

The present invention relates to a foldable bicycle. More particularly, the present invention relates to a foldable bicycle, in which folding structures are formed at plural parts of a body of the foldable bicycle, so that the volume of the foldable bicycle can be remarkably reduced and the storage and transportation of the foldable bicycle can be facilitated.

In general, a bicycle is extensively used for leisure or transportation in short distance. Recently, the bicycle is equipped with various functions so that the bicycle is spotlighted as a sport means for enabling persons to enjoy the leisure or exercise.

The bicycle generally has a long length and front and rear wheels are provided at front and rear portions of a frame, respectively. In order to facilitate the storage and transportation of the bicycle, a folding device is provided in the bicycle to fold or unfold the bicycle about the center of the frame. The folding device must have fixing force to ensure the safety of the bicycle. In detail, the folding device must have fixing force to keep the bicycle in an unfolded state even if external impact or load is applied to the bicycle. In addition, the folding device must allow the bicycle to be easily folded or unfolded.

However, the foldable bicycle according to the related art is provided with a plurality of folding devices, so that the foldable bicycle has a complicated structure and defect may frequently occur in the foldable bicycle. In addition, the weight of the bicycle may be increased due to the folding devices. Further, since the folding parts have weak structures, the bicycle may be deformed if impact is applied to the bicycle, so that accidents may occur when a user rides on the bicycle.

For instance, in a case in which a folding part is provided at the center of a connection frame that connects a front frame with a rear frame to horizontally fold the bicycle such that the front wheel overlaps with the rear wheel, the length of the bicycle can be shortened. However, a handle may protrude outward so that a relatively large space is required to store the bicycle.

In addition, since the folding part having the hinge structure is provided at one portion of the bicycle, the folding part may be gradually released as time has elapsed. In extreme case, the folding part may be broken so that the life span of the bicycle may be shortened. Further, since the folding part is provided only at one portion of the bicycle, the thickness and the size of the connection frame where the folding part is installed is increased, so that the aesthetic appearance of the bicycle may be deteriorated.

### SUMMARY

The present invention has been made to solve the problems occurring in the prior art, and an object of the present invention is to provide a foldable bicycle, in which folding structures are formed at plural parts of a body of the foldable bicycle, so that the volume of the foldable bicycle can be remarkably reduced and the storage and transportation of the foldable bicycle can be facilitated.

Another object of the present invention is to provide a foldable bicycle capable of improving riding comfort and safety through the interaction of the weight of the human body and the gravity.

In order to accomplish the above objects, according to one embodiment of the present invention, there is provided a foldable bicycle including a head frame supporting a front wheel and having a first connection part at an upper portion thereof; a first lower frame having a rod shape, which is integrally formed with the head frame at a lower end of the first connection part while extending to a pedal of the foldable bicycle and provided at a terminal end thereof with a second fastening part; a second lower frame having a rod shape, which supports a rear wheel, has a perforation hole into which a central shaft of the pedal is inserted, and is provided with a second connection part extending from one side of the perforation hole and moving in correspondence with the second fastening part; a slide member coupled with the second lower frame to slidably move lengthwise along the second lower frame and provided at an upper portion thereof with a third connection part; a saddle frame provided at a lower portion thereof with a third fastening part rotatably coupled with the third connection part; and a horizontal frame provided at one end thereof with a fourth fastening part rotatably coupled with saddle frame, and at the other end thereof with a first fastening part rotatably coupled with a first connection part provided in the head frame.

The foldable bicycle may further include a fourth connection part provided at a rear portion of the second connection part of the second lower frame and an auxiliary connection part corresponding to the fourth connection part, wherein a guide member having a rod shape is coupled to the fourth connection part and the auxiliary connection part lengthwise along the second lower frame of the foldable bicycle, and the slide member is coupled with the guide member to slidably move lengthwise along the guide member.

The foldable bicycle may further include a fifth connection part installed at a center of the saddle frame and directed rearward of the foldable bicycle; a sixth connection part having a hook shape and provided at an upper rear portion of the slide member; and a damping device coupled with the fifth and sixth connection parts.

The foldable bicycle may further include a seventh connection part provided at an upper portion of the saddle frame while protruding rearward of the foldable bicycle; a carrier or a rear saddle including a seventh fastening part rotatably coupled with the seventh connection part; an eighth connection part provided at a lower portion of the carrier or the rear saddle; a ninth connection part provided at an upper portion of the slide member; and a support provided at both ends thereof with eighth and ninth fastening parts rotatably coupled with the eighth and ninth connection parts.

The foldable bicycle may further include a blocking member provided at an upper rear portion of the second connection part to prevent the first and second lower frames from rotating excessively.

The foldable bicycle may further include first and second folding members provided at centers of the first lower frame and the horizontal frame, respectively.

At least one of the first and second folding members may include a hollow body inserted into the first lower frame or the horizontal frame having a female screw, formed at an outer surface thereof with a male screw corresponding to the female screw, provided at one end thereof with an expansion part and formed therein with a step portion; a cap coupled to an opposite end of the hollow body in opposition to the expansion part; an elastic member to support the cap; an extension member elastically supported by the elastic member and including a cylindrical body making contact with the step portion of the hollow body and a protrusion extending from the cylindrical body and protruding out of the hollow body; and a fixing member having a hemispherical shape and coupled with a terminal end of the protrusion of the extension member.

A handle may be inserted into the head frame and a hinge may be provided in the handle to fold the handle.

The hinge of the handle may be rotatable at an angle of 90°.

According to the present invention, the foldable bicycle has a plurality of folding devices, so that the volume of the foldable bicycle can be reduced in the folding state. Thus, the foldable bicycle can be easily stored in a narrow space, such as an indoor room or a vehicle. In addition, a user can easily carry the foldable bicycle when the user uses the public transportation.

In addition, the user can rapidly and easily manipulate the folding device when the user rides on the foldable and the riding comfort and safety of the foldable bicycle can be improved through the interaction of the weight of the human body and the gravity. Further, the durability of the folding devices can be improved and the aesthetic appearance of the foldable bicycle can be improved.

### BRIEF DESCRIPTION OF THE DRAWINGS

FIG. 1 is a side view showing an unfolded state of a foldable bicycle according to the first embodiment of the present invention;

FIG. 2 is a side view showing a foldable bicycle being folded according to the first embodiment of the present invention;

FIG. 3 is a side view showing a folded state of a foldable bicycle according to the first embodiment of the present invention;

FIG. 4 is a side view showing an unfolded state of a foldable bicycle according to the second embodiment of the present invention;

FIG. 5 is a side view showing a foldable bicycle being folded according to the second embodiment of the present invention;

FIG. 6 is a side view showing a folded state of a foldable bicycle according to the second embodiment of the present invention;

FIG. 7 is a side view showing an unfolded state of a foldable bicycle according to the third embodiment of the present invention;

FIG. 8 is a side view showing a foldable bicycle being folded according to the third embodiment of the present invention;

FIG. 9 is a side view showing a folded state of a foldable bicycle according to the third embodiment of the present invention;

FIG. 10 is a side view showing an unfolded state of a foldable bicycle according to the fourth embodiment of the present invention;

FIG. 11 is a side view showing a foldable bicycle being folded according to the fourth embodiment of the present invention;

FIG. 12 is a side view showing a folded state of a foldable bicycle according to the fourth embodiment of the present invention;

FIG. 13 is an exploded perspective view of a folding member according to the fourth embodiment of the present invention; and

FIG. 14 is a partially sectional view of a folding member according to the fourth embodiment of the present invention.

### DETAILED DESCRIPTION OF THE EMBODIMENTS

Hereinafter, exemplary embodiments of the present invention will be described with reference to accompanying drawings.

A bicycle 10 described in the present specification signifies a foldable bicycle which may include a chain-type bicycle propelled by a pedal 850 and a sprocket, a chainless bicycle and a motored bicycle generally known as “moped”.

### First Embodiment

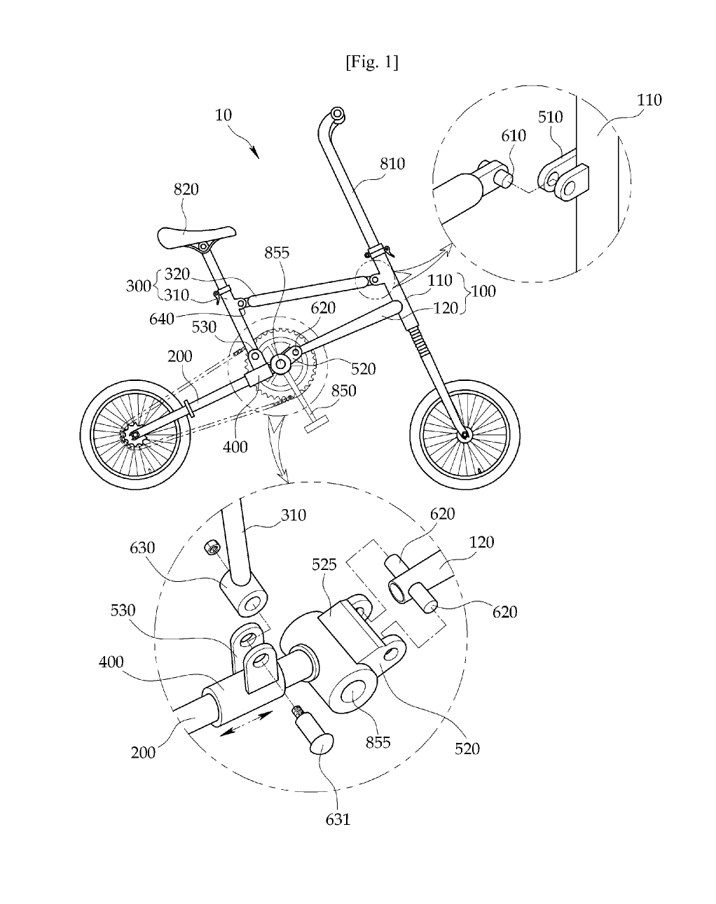

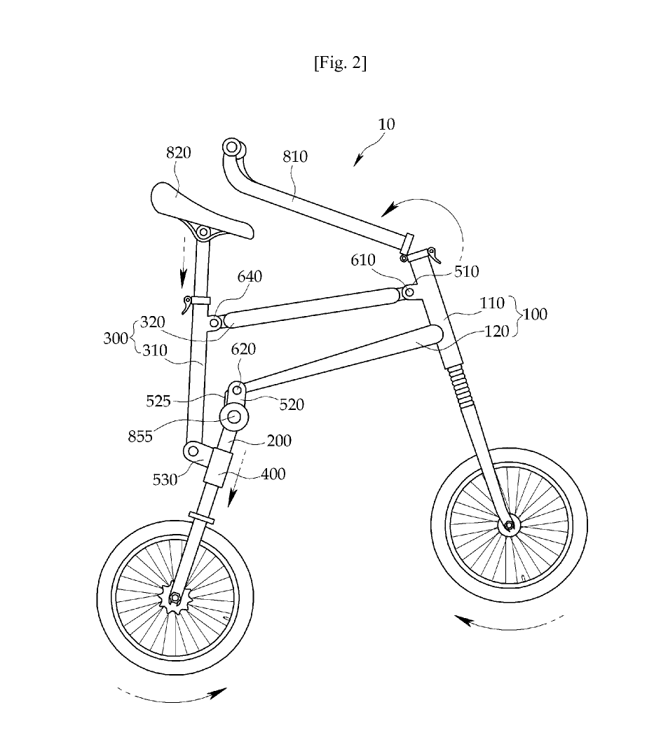

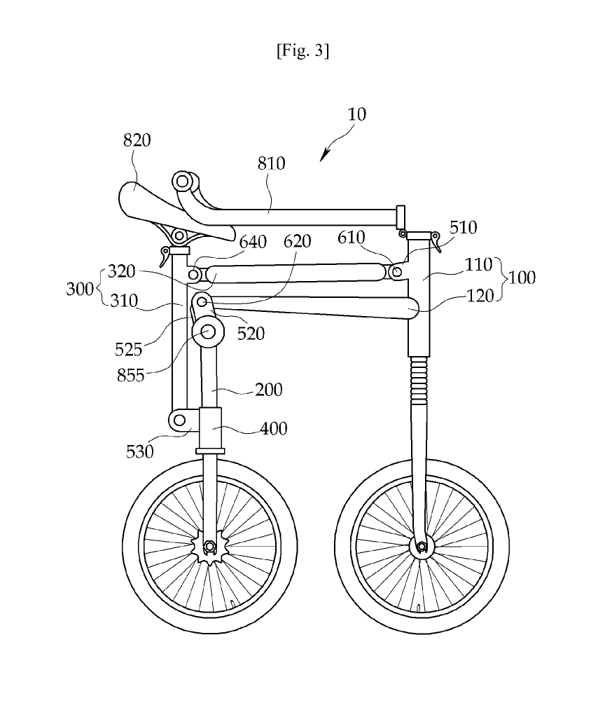

FIG. 1 is a side view showing an unfolded state of a foldable bicycle according to the first embodiment of the present invention, FIG. 2 is a side view showing the foldable bicycle being folded according to the first embodiment of the present invention, and FIG. 3 is a side view showing a folded state of the foldable bicycle according to the first embodiment of the present invention. As shown in FIGS. 1 to 3, a frame of the foldable bicycle 10 according to the first embodiment of the present invention includes three frames and a slide member 400. The three frames include a front frame 100 having a head frame 110 and a first lower frame 120 integrally formed with the head frame 110, a second lower frame 200, and an upper frame 300 having a saddle frame 310 and a horizontal frame 320 integrally formed with the saddle frame 310.

In detail, the front frame 100 according to the first embodiment includes a head frame 110 and a first lower frame 120. The head frame 110 constitutes a front part of the foldable bicycle 10. A front fork is provided at a lower end of the head frame 110 and a handle 810 is provided at an upper end of the head frame 110. The handle 810 is provided with a hinge and coupled with the front frame 100 in such a manner that the handle 810 can be folded to the rear part of the body of the bicycle 10. In addition, a first connection part 510 is provided at one side of the upper portion of the head frame 110. Preferably, the first connection part 510 protrudes rearward. The first connection part 510 includes two plate members, which are spaced apart from each other and formed at the center thereof with holes into which the hinge or a support pin is inserted.

According to the present invention, the first connection part 510 includes two plate members formed at the center thereof with holes and a fastening part is rotatably coupled with the first connection part 510. However, the connection parts and fastening parts described in the embodiments of the present invention may have various shapes if they can be rotatably coupled with each other.

The first lower frame 120 according to the first embodiment of the present invention is provided at one side of a lower portion of the head frame 110. Preferably, the first lower frame 120 is a rod member, which is spaced apart from the first connection part 510 and extends to a perforation hole 855 into which a central shaft of a pedal 850 of the foldable bicycle 10 is inserted. The first lower frame 120 is integrally formed with the head frame 110. A second fastening part 620, which is formed with a hole into which the hinge or the support pin is inserted, is provided at the lower end of the first lower frame 120.

The second lower frame 200 according to the first embodiment of the present invention is provided at one end thereof with a rear fork for supporting a rear wheel. In addition, the perforation hole 855 is formed at the other end of the second lower frame 200. The central shaft of the pedal 850 of the foldable bicycle 10 is inserted into the perforation hole 855. A second connection part 520 extends from one side of the perforation hole 855. The second connection part 520 has a rod shape and is coupled with the second fastening part 620. The second connection part 520 has the shape identical to that of the first connection part 510. In addition, a blocking member 525 is provided at an upper rear portion of the second connection part 520 to prevent the first and second lower frames 120 and 200 from rotating excessively. The blocking member 525 may prevent the foldable bicycle 10 from being deformed by external impact.

The slide member 400 according to the first embodiment of the present invention has the shape corresponding to the shape of the second lower frame 200 and slidably moves lengthwise along the second lower frame 200. The slide member 400 can be divided into upper and lower parts by means of a hinge to facilitate the repair and fastening work for the slide member 400. A third connection part 530 is provided at an upper portion of the slide member 400 such that the slide member 400 can be coupled with the saddle frame 310. The third connection part 530 has the shape identical to the shape of the first connection part 530.

The saddle frame 310 according to the first embodiment has a hollow pipe shape into which a saddle part is inserted. A switch is provided at an upper end of the saddle frame 310 to adjust the length of the saddle part, and a third fastening part 630 is provided at a lower portion of the saddle frame 310. The third fastening part 630 is rotatably coupled with the third connection part 530 of the second lower frame 200. The third fastening part 630 has the shape identical to the shape of the second fastening part 620.

The horizontal frame 320 according to the first embodiment of the present invention is provided at one end thereof with a fourth fastening part 640 rotatably coupled with the saddle frame 310. In addition, the horizontal frame 320 is provided at the other end thereof with a first fastening part 610 having the shape corresponding to the shape of the first connection part 510 provided in the head frame 110.

The fourth and first fastening parts 640 and 610 have the shape identical to the shape of the second fastening part 620. The fourth and first fastening parts 640 and 610 are rotatably installed by means of a shaft pin.

The horizontal frame 320 may be employed in the second to fourth embodiments described later and detailed description thereof will be omitted in order to avoid redundancy.

The frames used in the present invention are made from rigid metals or metallic materials and have the hollow structure to reduce the weight of the foldable bicycle 10.

The foldable bicycle 10 according to the first embodiment of the present invention is used in the unfolded state as shown in FIG. 1. If it is necessary to fold the foldable bicycle 10 for the purpose of storage or transportation, a coupling part between the first lower frame 120 and the second lower frame 200 is lifted up as shown in FIG. 2, so that the slide member 400 coupled with the saddle frame 310 moves toward the rear wheel along the second lower frame 200. Thus, the body of the foldable bicycle 10 is folded in the form of Π shape as shown in FIG. 3.

In detail, the coupling part between the first lower frame 120 and the second lower frame 200 is moved up in the vicinity of the saddle frame 310 integrally formed with the horizontal frame 320, so that the body of the foldable bicycle 10 is folded. Then, a saddle 820 is pushed toward the saddle frame 310 by adjusting the switch for fixing the saddle 820 and the handle 810 is folded to the saddle 820.

### Second Embodiment

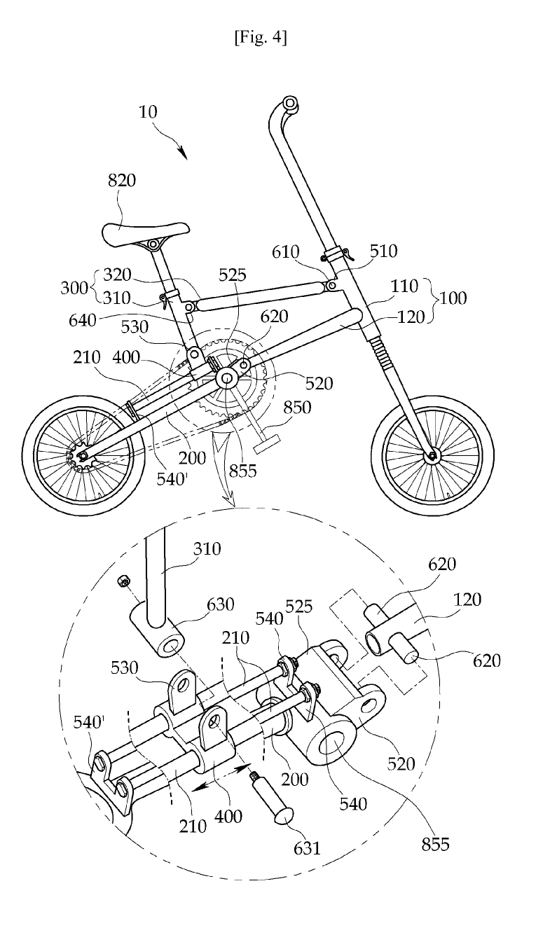

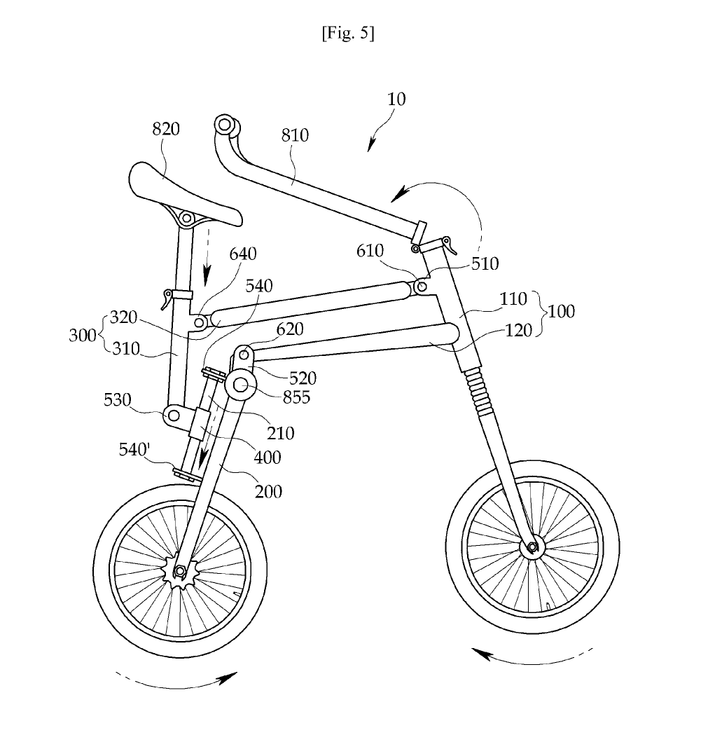

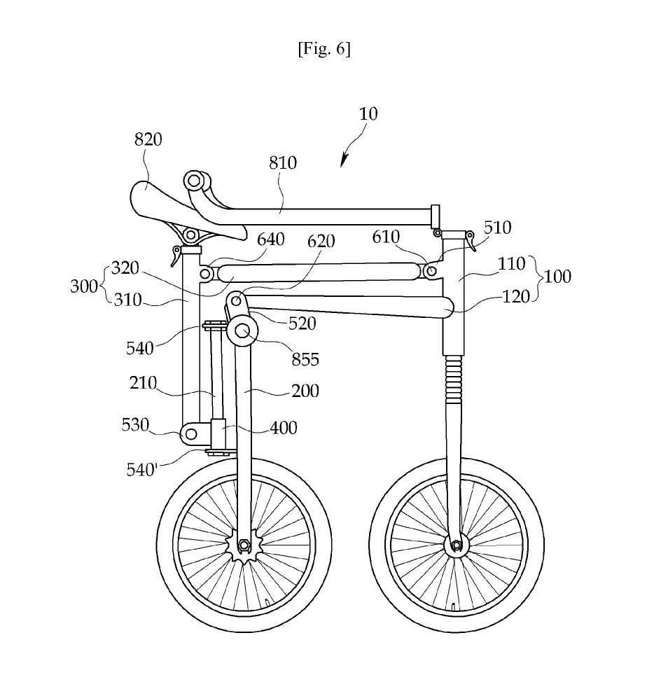

FIG. 4 is a side view showing an unfolded state of a foldable bicycle according to the second embodiment of the present invention, FIG. 5 is a side view showing the foldable bicycle being folded according to the second embodiment of the present invention, and FIG. 6 is a side view showing the folded state of the foldable bicycle according to the second embodiment of the present invention. As shown in FIGS. 4 to 6, the foldable bicycle 10 according to the second embodiment of the present invention is substantially similar to the foldable bicycle according to the first embodiment of the present invention.

According to the second embodiment of the present invention, a fourth connection part 540 is provided at a rear portion of the second connection part 520 formed at the terminal end of the second lower frame 200.

The fourth connection part 540 is formed with a perforation hole such that a central shaft extends through the perforation hole lengthwise along the second lower frame 200 of the foldable bicycle 10.

The fourth connection part 540 may include at least one perforation hole. According to the second embodiment of the present invention, two perforation holes are formed in the fourth connection part 540.

Guide members 210 having the rod shape are inserted into the perforation holes of the fourth connection part 540 lengthwise along the second lower frame 200 of the foldable bicycle 10.

The guide members 210 may be fastened to the fourth connection part 540 by a screw or a bolt or may be welded to the fourth connection part 540 after the guide members 210 have been inserted into the fourth connection part 540.

In addition, a head of a screw coupled to the terminal end of the guide member 210 connected to the fourth connection part 540 is larger than a diameter of the guide member 210.

Since only one side of the guide member 210 is fixed by the screw, the load may be applied to the fourth connection part 540. In order to reduce the load, an auxiliary connection part 540′ having the shape identical to the shape of the fourth connection part 540 is provided at the distal end of the guide member 210 in opposition to the fourth connection part 540. The auxiliary connection part 540′ is integrally formed with the second lower frame 200 and coupled with the guide member 210.

Since the guide member 210 is provided between the fourth connection part 540 and the auxiliary connection part 540′, the guide member 210 is moved integrally with the second lower frame 200 while stably supporting the load of the user.

The slide member 400 according to the second embodiment of the present invention is coupled with the guide member 210, other than the second lower frame 200.

Since the slide member 400 is coupled with the guide member 210, an inner diameter of the slide member 400 corresponds to an outer diameter of the guide member 210 such that the slide member 400 may slide lengthwise along the guide member 210.

The foldable bicycle 10 according to the second embodiment of the present invention is used in the unfolded state as shown in FIG. 4. If it is necessary to fold the foldable bicycle 10 for the purpose of storage or transportation, a coupling part between the first lower frame 120 and the second lower frame 200 is lifted up as shown in FIG. 5, so that the slide member 400 coupled with the saddle frame 310 moves toward the rear wheel along the guide member 210. Thus, the body of the foldable bicycle 10 is folded in the form of Π shape as shown in FIG. 6.

In detail, the coupling part between the first lower frame 120 and the second lower frame 200 is moved up in the vicinity of the saddle frame 310 coupled with the horizontal frame 320, so that the body of the foldable bicycle 10 is folded.

Then, the saddle 820 is pushed toward the saddle frame 310 by adjusting the switch for fixing the saddle 820 and the handle 810 is folded to the saddle 820.

### Third Embodiment

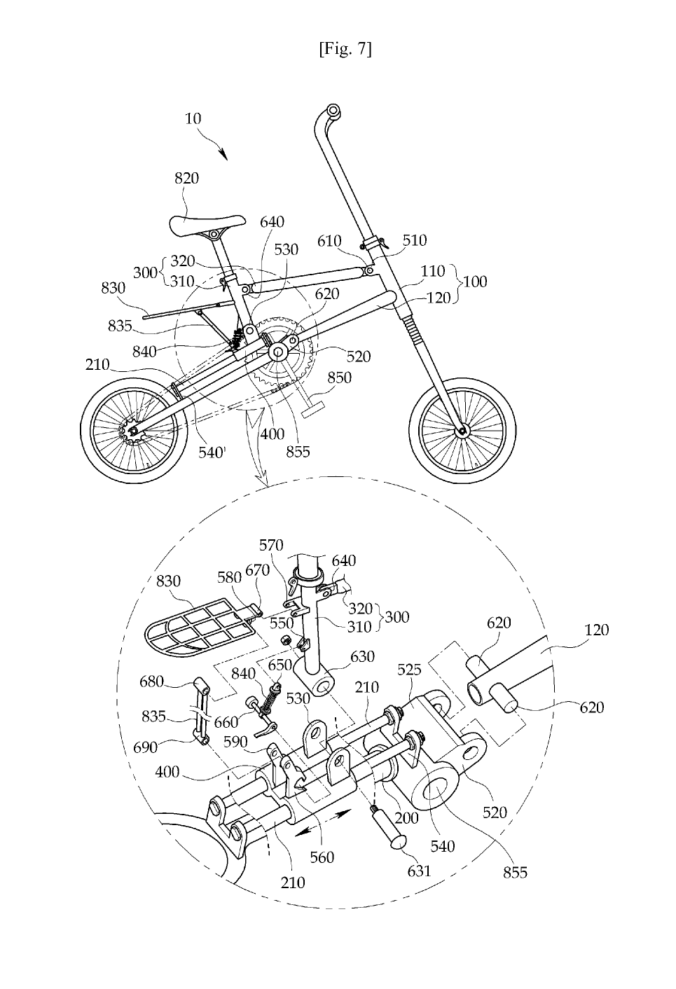

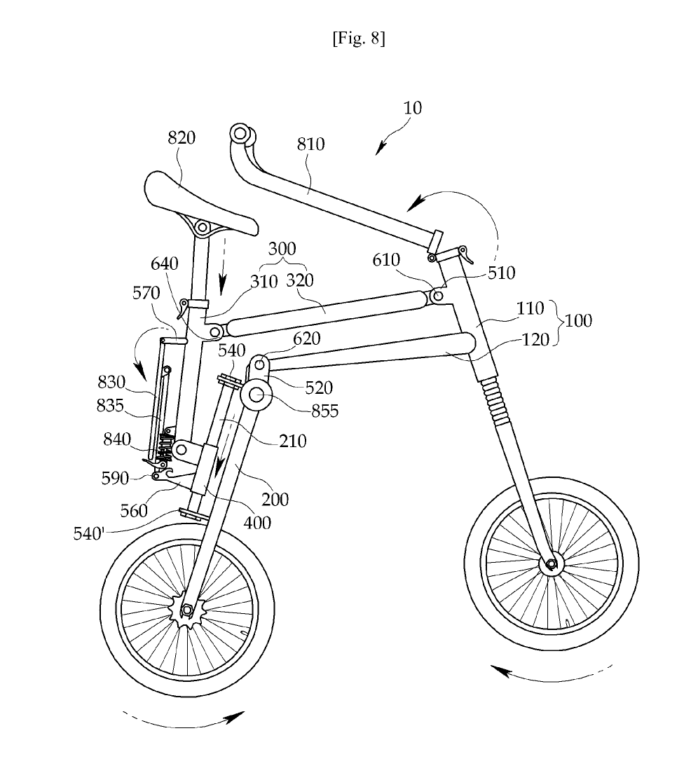

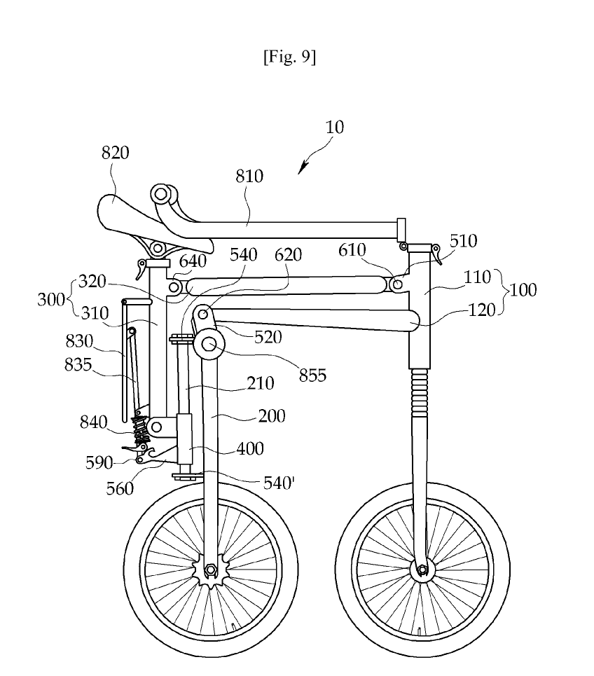

FIG. 7 is a side view showing an unfolded state of a foldable bicycle according to the third embodiment of the present invention, FIG. 8 is a side view showing the foldable bicycle being folded according to the third embodiment of the present invention, and FIG. 9 is a side view showing a folded state of the foldable bicycle according to the third embodiment of the present invention. The foldable bicycle according to the third embodiment of the present invention is similar to the foldable bicycle according to the first and second embodiments of the present invention. However, according to the third embodiment of the present invention, a carrier 830 or a rear saddle is provided at a rear portion of the saddle 820 and a damping device 840 is provided to absorb shock applied to the foldable bicycle 10.

In order to install the damping device 840 in the foldable bicycle 10, a fifth connection part 550 is provided at the center of the saddle frame 310 such that the fifth connection part 550 is directed to the rear portion of the foldable bicycle 10. In addition, a sixth connection part 560 is provided at an upper portion of the slide member 400. Preferably, the sixth connection part 560 is provided at a rear side of the third connection part 530 and has a hook shape with an open lower portion. The damping device 840 connects the fifth connection part 550 with the sixth connection part 560. Fifth and sixth fastening parts 650 and 660 are provided at both ends of the damping device 840 corresponding to the fifth and sixth connection parts 550 and 560. A hinge or a fixing pin 631 is inserted into the fifth and sixth fastening parts 650 and 660. The length of the sixth fastening part 660 is adjustable by using a switch. If the length of the sixth fastening part 660 is compressed by manipulating the switch, the sixth fastening part 660 is locked with the sixth connection part 560 having the hook shape. In addition, if the length of the sixth fastening part 660 is expanded by manipulating the switch, the sixth fastening part 660 is separated from the sixth connection part 560.

According to the third embodiment of the present invention, a seventh connection part 570 is provided at an upper portion of the saddle frame 310 to install the carrier 830 or the rear saddle. The seventh connection part 570 protrudes rearward of the foldable bicycle 10. In addition, a seventh fastening part 670 corresponding to the seventh connection part 570 is movably installed at the terminal end of the carrier 830 or the rear saddle. Further, an eighth connection part 570 is provided at a lower portion of the carrier 830 or the rear saddle, and a ninth connection part 590 is provided at an upper portion of the slide member 400. The ninth connection part 590 can be directly installed on the slide member 400 by taking the size of the slide member 400 into consideration. In addition, the ninth connection part 590 can be additionally formed on the sixth connection part 560 to couple the damping device 840. The eighth and ninth connection parts 580 and 590 support the carrier 830 or the rear saddle. A support 835 provided at both ends thereof with eighth and ninth fastening parts 680 and 690 is connected to the eighth and ninth connection parts 580 and 590.

The carrier 830, the rear saddle and the damping device 840 according to the third embodiment of the present invention can be applied to the first and second embodiments of the present invention.

The foldable bicycle 10 according to the third embodiment of the present invention is used in the unfolded state as shown in FIG. 7. If it is necessary to fold the foldable bicycle 10 for the purpose of storage or transportation, the damping device 840 is released by adjusting the switch of the sixth fastening part 660 of the damping device 840 and the damping device 840 is separated from the sixth connection part 560 having the hook shape with the open lower portion. Then, a coupling part between the first lower frame 120 and the second lower frame 200 is lifted up as shown in FIG. 8, so that the slide member 400 coupled with the saddle frame 310 moves toward the rear wheel along the guide member 210. Thus, the body of the foldable bicycle 10 is folded in the form of Π shape as shown in FIG. 9. At this time, the support 835 connected to the slide member 400 also moves rearward together with the slide member 400 and the carrier 830 or the rear saddle is folded downward. In detail, the coupling part between the first lower frame 120 and the second lower frame 200 is moved up in the vicinity of the saddle frame 310 coupled with the horizontal frame 320, so that the body of the foldable bicycle 10 is folded. Then, a saddle 820 is pushed toward the saddle frame 310 by adjusting the switch for fixing the saddle 820 and the handle 810 is folded to the saddle 820.

### Fourth Embodiment

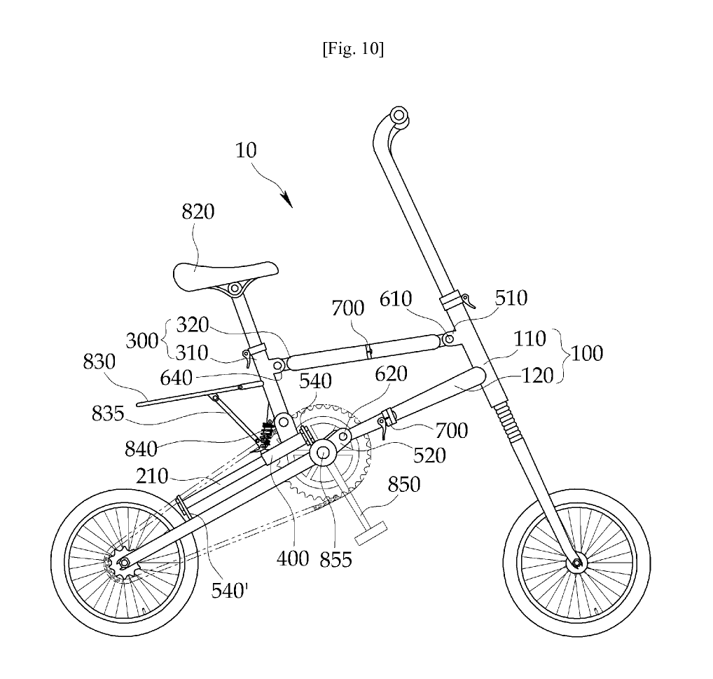

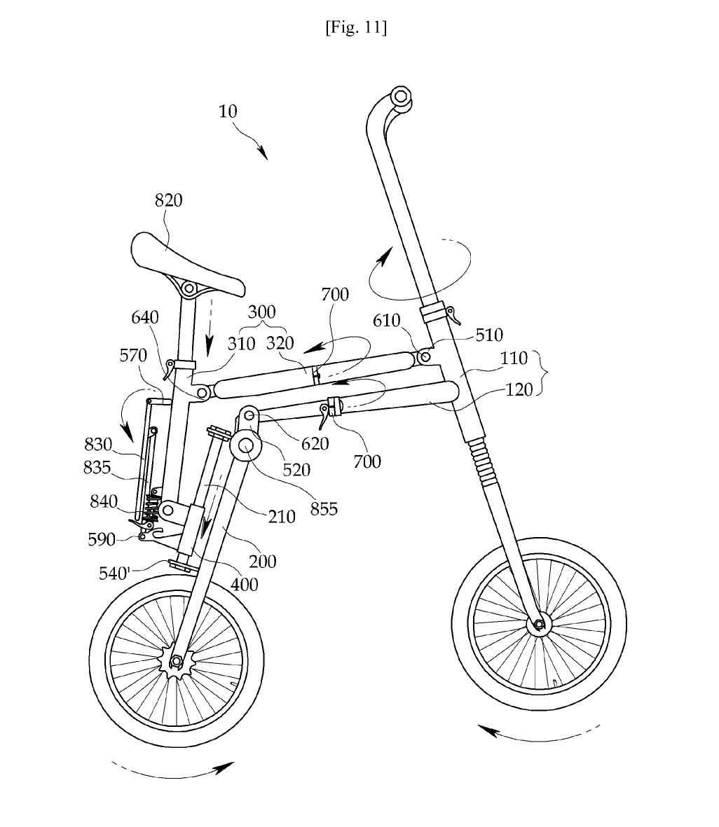

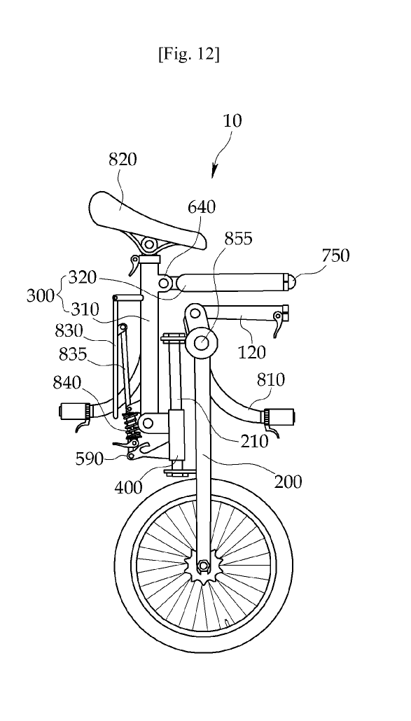

FIG. 10 is a side view showing an unfolded state of a foldable bicycle according to the fourth embodiment of the present invention, FIG. 11 is a side view showing the foldable bicycle being folded according to the fourth embodiment of the present invention, and FIG. 12 is a side view showing a folded state of the foldable bicycle according to the fourth embodiment of the present invention. As shown in FIGS. 10 to 12, the foldable bicycle according to the fourth embodiment of the present invention is similar to the foldable bicycle according to the first to third embodiments of the present invention. However, according to the fourth embodiment of the present invention, folding members 700, which can be folded in the lateral direction of the body of the foldable bicycle 10, are provided at the centers of the horizontal frame 320 and the first lower frame 120, respectively, in order to reduce the volume of the foldable bicycle 10. The folding members 700 allow the front and rear wheels to be coaxially arranged when the foldable bicycle 10 is folded, so that the volume of the foldable bicycle 10 can be reduced. The folding members 700 can be folded by using a hinge-type elastic switch. In addition, in order to solve the inconvenience of the hinge-type elastic switch and to improve the fixing force, the folding members 700 may have the structure described below.

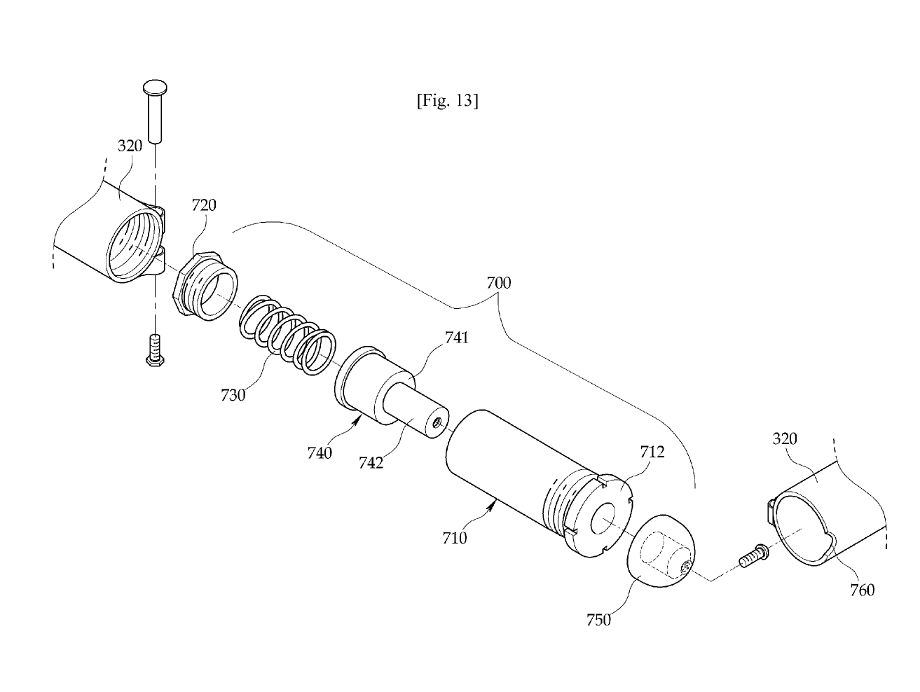

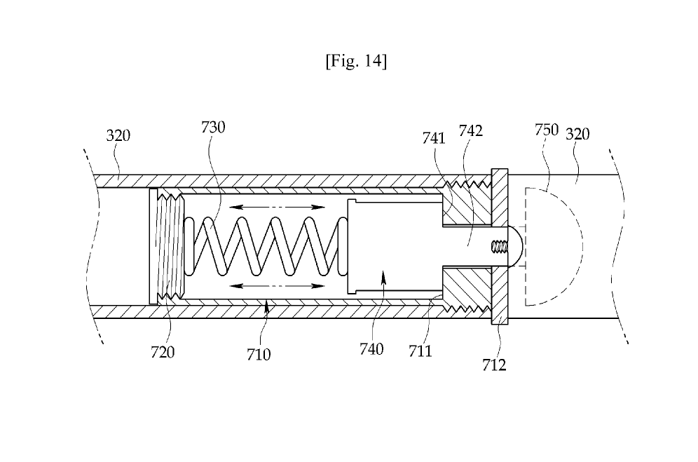

FIG. 13 is an exploded perspective view of the folding member 700 according to the fourth embodiment of the present invention, and FIG. 14 is a partially sectional view of the folding member 700 according to the fourth embodiment of the present invention. The folding member 700 according to the present invention is provided in at least one of the horizontal frame 320 and the first lower frame 120 and has a hinge rotatable in one direction. The folding member 700 is inserted into the horizontal frame 320 or the first lower frame 120 and a female screw is formed in the horizontal frame 320 or the first lower frame 120.

As shown in FIGS. 13 and 14, the folding member 700 according to the present invention includes a body 710, a cap 720, an elastic member 730, an extension member 740 and a fixing member 750. The folding member 700 according to the fourth embodiment of the present invention is provided in the horizontal frame 320.

The body 710 of the folding member 700 according to the present invention is inserted into the horizontal frame 320 formed therein with the female screw. The body 710 has a cylindrical shape and a male screw corresponding to the female screw of the horizontal frame 320 is formed on the outer surface of the body 710. In addition, an expansion part 712 is formed at one end of the body 710 to prevent the body 710 from being completely inserted into the horizontal frame 320. A step portion 711 is provided in the body 710 in the vicinity of the male screw of the body 710. In addition, a female screw is formed at the other end of the body 710 in opposition to the step portion 711.

The cap 720 is provided at an outer surface thereof with a male screw corresponding to the female screw formed at the other end of the body 710.

The elastic member 730 is installed in the body 710 while being supported by the cap 720. Preferably, the elastic member 730 includes a spring.

The extension member 740 is inserted into the body 710 while being elastically supported by the elastic member 730. The extension member 740 has a cylindrical body 741 making contact with the step portion 711 of the body 710. A protrusion 742 extends from the cylindrical body 751 of the extension member 740. The protrusion 742 protrudes out of the body 710.

The fixing member 750 has a hemispherical shape and is coupled with the terminal end of the protrusion 742. Preferably, the fixing member 750 is made from an elastic material, such as rubber or high-density resin. Semicircular grooves 760 are formed at the front end of the horizontal frame 320 to allow the fixing member 750 to be easily inserted into or separated from the horizontal frame 320. If the size of the semicircular grooves 760 is too small, the body of the foldable bicycle 10 may not be easily folded. In contrast, if the size of the semicircular grooves 760 is too large, the fixing member 350 may not sufficiently support the horizontal frame 320 so that the body of the foldable bicycle 10 may be unintentionally folded as external impact is applied thereto, causing the accident. Preferably, the semicircular groove 760 has the size corresponding to 10% to 20% based on the size of the fixing member 750.

When the foldable bicycle 10 according to the fourth embodiment of the present invention is folded by means of the folding member 700, the front and rear forks support one side of the front and rear wheels of the foldable bicycle 10, other than both sides of the front and rear wheels of the foldable bicycle 10 in such a manner that the front fork does not make contact with the rear fork.

The handle 810 of the foldable bicycle 10 according to the fourth embodiment of the present invention includes a hinge member. The hinge member is provided at an end of the handle 810 making contact with the head frame 110 such that the hinge member can rotatably move to the left or right at the angle of 90°. The hinge member may be slantingly installed by taking into consideration the rotating angle and the rotating direction of the handle 810 of the foldable bicycle 10 or a rotation member may be additionally provided.

The folding member 700 for the horizontal frame 320 and the first lower frame 120 according to the fourth embodiment of the present invention can be applied to the first to third embodiments of the present invention.

The foldable bicycle 10 according to the fourth embodiment of the present invention is used in the unfolded state as shown in FIG. 10. If it is necessary to fold the foldable bicycle 10 for the purpose of storage or transportation, the damping device 840 is released by adjusting the switch of the sixth fastening part 660 of the damping device 840 and the damping device 840 is separated from the sixth connection part 560 having the hook shape with the open lower portion. Then, a coupling part between the first lower frame 120 and the second lower frame 200 is lifted up as shown in FIG. 11, so that the slide member 400 coupled with the saddle frame 310 moves toward the rear wheel along the guide member 210. Thus, the body of the foldable bicycle 10 is folded in the form of Π shape. At this time, the support 835 connected to the slide member 400 also moves rearward together with the slide member 400 and the carrier 830 or the rear saddle is folded downward. In detail, the coupling part between the first lower frame 120 and the second lower frame 200 is moved up in the vicinity of the saddle frame 310 coupled with the horizontal frame 320, so that the body of the foldable bicycle 10 is folded. Then, as shown in FIG. 12, the foldable bicycle 10 is folded by using the folding member provided in the horizontal frame 320 and the first lower frame 120 in such a manner that the front and rear wheels are coaxially arranged. After that, the saddle 820 is pushed toward the saddle frame 310 by adjusting the switch for fixing the saddle 820 and the handle 810 is folded to the saddle 820 by rotating the handle 810 at an angle of 90° using the hinge member.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A foldable bicycle comprising:
a head frame supporting a front wheel and having a first connection part at an upper portion thereof;
a first lower frame having a rod shape, which is integrally formed with the head frame at a lower end of the first connection part while extending to a pedal of the foldable bicycle and provided at a terminal end thereof with a second fastening part;
a second lower frame having a rod shape, which supports a rear wheel, has a perforation hole into which a central shaft of the pedal is inserted, and is provided with a second connection part extending from one side of the perforation hole and moving in correspondence with the second fastening part;
a slide member coupled with the second lower frame to slidably move lengthwise along the second lower frame and provided at an upper portion thereof with a third connection part;
a saddle frame provided at a lower portion thereof with a third fastening part rotatably coupled with the third connection part; and
a horizontal frame provided at one end thereof with a fourth fastening part rotatably coupled with saddle frame, and at the other end thereof with a first fastening part rotatably coupled with a first connection part provided in the head frame.

2. The foldable bicycle of claim 1, further comprising a fourth connection part provided at a rear portion of the second connection part of the second lower frame and an auxiliary connection part corresponding to the fourth connection part, wherein a guide member having a rod shape is coupled to the fourth connection part and the auxiliary connection part lengthwise along the second lower frame of the foldable bicycle, and the slide member is coupled with the guide member to slidably move lengthwise along the guide member.

3. The foldable bicycle of claim 1, further comprising:
a fifth connection part installed at a center of the saddle frame and directed rearward of the foldable bicycle;
a sixth connection part having a hook shape and provided at an upper rear portion of the slide member; and
a damping device coupled with the fifth and sixth connection parts.

4. The foldable bicycle of claim 1, further comprising:
a seventh connection part provided at an upper portion of the saddle frame while protruding rearward of the foldable bicycle;
a carrier or a rear saddle including a seventh fastening part rotatably coupled with the seventh connection part;
an eighth connection part provided at a lower portion of the carrier or the rear saddle;
a ninth connection part provided at an upper portion of the slide member; and
a support provided at both ends thereof with eighth and ninth fastening parts rotatably coupled with the eighth and ninth connection parts.

5. The foldable bicycle of claim 1, further comprising a blocking member provided at an upper rear portion of the second connection part to prevent the first and second lower frames from rotating excessively.

6. The foldable bicycle of claim 1, further comprising first and second folding members provided at centers of the first lower frame and the horizontal frame, respectively.

7. The foldable bicycle of claim 6, wherein at least one of the first and second folding members includes:
a hollow body inserted into the first lower frame or the horizontal frame having a female screw, formed at an outer surface thereof with a male screw corresponding to the female screw, provided at one end thereof with an expansion part and formed therein with a step portion;
a cap coupled to an opposite end of the hollow body in opposition to the expansion part;
an elastic member to support the cap;
an extension member elastically supported by the elastic member and including a cylindrical body making contact with the step portion of the hollow body and a protrusion extending from the cylindrical body and protruding out of the hollow body; and
a fixing member having a hemispherical shape and coupled with a terminal end of the protrusion of the extension member.

8. The foldable bicycle of claim 1, wherein a handle is inserted into the head frame and a hinge is provided in the handle to fold the handle.

9. The foldable bicycle of claim 8, wherein the hinge of the handle is rotatable at an angle of 90°.
